(19) United States
(12) Patent Application Publication
(10) Pub. No.: US 2026/0017768 A1
(43) Pub. Date: Jan. 15, 2026

(54) VIDEO PROCESSING APPARATUS, VIDEO PROCESSING SYSTEM, AND VIDEO PROCESSING METHOD

(71) Applicant: NEC CORPORATION, Minato-ku, Tokyo (JP)

(72) Inventors: Ryuhei ANDO, Tokyo (JP); Katsuhiko TAKAHASHI, Tokyo (JP); Yasunon BABAZAKI, Tokyo (JP); Jun PIAO, Tokyo (JP); Takanori IWAI, Tokyo (JP); Koichi NIHEI, Tokyo (JP); Florian BEYE, Tokyo (JP); Hayato ITSUMI, Tokyo (JP)

(73) Assignee: NEC CORPORATION, Minato-ku, Tokyo (JP)

(21) Appl. No.: 18/993,029

(22) PCT Filed: Aug. 16, 2022
(86) PCT No.: PCT/JP2022/030974

§ 371 Date: Jan. 10, 2025

(51) Int. Cl. G06T 7/00; G06V 10/82; G06V 40/20

(52) U.S. Cl. CPC G06T 7/0002; G06V 10/82; G06V 40/20; G06T 2207/10016; G06T 2207/30168; G06V 2201/07

(57) ABSTRACT

A video processing apparatus according to one aspect of the present example embodiment includes: at least one memory configured to store instructions; and at least one processor configured to execute the instructions to: generate image quality feature information indicating a feature of image quality information indicating an image quality of a video in time and space; generate integrated data obtained by integrating information regarding a video including a feature of the video in time and space and the image quality feature information; and execute recognition processing on a subject included in the video based on the integrated data.

### TECHNICAL FIELD

The present disclosure relates to a video processing apparatus, a video processing system, and a video processing method.

### BACKGROUND ART

Technologies related to video processing have been developed in recent years.

For example, Patent Literature 1 discloses a method for identifying a predetermined object from image data that can include the object in an image in a cloud server. Specifically, at the time video data including image data is encoded, the cloud server generates an encoding parameter feature amount that is a feature amount for mapping information in which an encoding parameter determined for each unit image section is mapped to the unit image section, and an image feature amount that is a feature amount related to a pixel value of the image data. In addition, the cloud server causes a trained discriminator to input the generated encoding parameter feature amount and image feature amount and output information regarding a predetermined object class, thereby identifying the object from the image data.

Further, Patent Literature 2 discloses a moving image processing apparatus. The processing apparatus performs quantization processing of a face region so as to decrease a reduction width of a compression ratio in the face region if an area ratio of the face region to an entire input image is relatively large, and to increase the reduction width of the compression ratio in the face region if the area ratio of the face region to the entire input image is relatively small.

### CITATION LIST

### Patent Literature

Patent Literature 1: Japanese Unexamined Patent Application Publication No. 2021-043773

Patent Literature 2: Japanese Unexamined Patent Application Publication No. 2010-193441

### SUMMARY OF INVENTION

### Technical Problem

If a change in image quality occurs in a video used for recognition processing over time, there is a possibility that the recognition engine side cannot accurately recognize the changed video. The technology according to Patent Literature 1 intends to reduce the processing load by using the “encoding parameter feature amount” for the recognition processing, but does not solve such a problem. Also, the technology according to Patent Literature 2 in which the compression ratio is balanced between the face region and the other regions does not solve such a problem.

An object of the present disclosure is to provide a video processing apparatus, a video processing system, and a video processing method capable of suppressing an influence of a change in image quality even in a case where the change occurs in a video and improving accuracy of video recognition.

### Solution to Problem

A video processing apparatus according to one aspect of the present example embodiment includes: a feature information generation unit that generates image quality feature information indicating a feature of image quality information indicating an image quality of a video in time and space; an integration unit that generates integrated data obtained by integrating information regarding a video including a feature of the video in time and space and the image quality feature information generated by the feature information generation unit; and a recognition unit that executes recognition processing on a subject included in the video based on the integrated data.

A video processing system according to one aspect of the present example embodiment includes: a feature information generation unit that generates image quality feature information indicating a feature of image quality information indicating an image quality of a video in time and space; an integration unit that generates integrated data obtained by integrating information regarding a video including a feature of the video in time and space and the image quality feature information generated by the feature information generation unit; and a recognition unit that executes recognition processing on a subject included in the video based on the integrated data.

A video processing method according to one aspect of the present example embodiment is executed by a computer, the method including: generating image quality feature information indicating a feature of image quality information indicating an image quality of a video in time and space; generating integrated data obtained by integrating information regarding a video including a feature of the video in time and space and the image quality feature information; and executing recognition processing on a subject included in the video based on the integrated data.

### Advantageous Effects of Invention

According to the present disclosure, it is possible to provide a video processing apparatus, a video processing system, and a video processing method capable of suppressing an influence of a change in image quality even in a case where the change occurs in a video and improving accuracy of video recognition.

### BRIEF DESCRIPTION OF DRAWINGS

FIG. 1 is a block diagram illustrating an example of a video processing apparatus according to a first example embodiment.

FIG. 2 is a flowchart illustrating an example of representative processing of the video processing apparatus according to the first example embodiment.

FIG. 3 is a block diagram illustrating an example of a video processing system according to the first example embodiment.

FIG. 4 is a block diagram illustrating an example of a video recognition system according to a second example embodiment.

FIG. 5A is a block diagram illustrating an example of a center server according to the second example embodiment.

FIG. 5B is a block diagram illustrating an example of a compressed information integration unit according to the second example embodiment.

FIG. 6A is a diagram illustrating an example of QP map information.

FIG. 6B is a diagram illustrating an example of generated attention map information.

FIG. 7 is a flowchart illustrating an example of representative processing of the center server according to the second example embodiment.

FIG. 8 is a block diagram illustrating another example of the compressed information integration unit according to the second example embodiment.

FIG. 9 is a block diagram illustrating an example of a hardware configuration of an apparatus according to each example embodiment.

### Example Embodiment

Hereinafter, each example embodiment will be described with reference to the drawings. Further, the following description and drawings are omitted and simplified as appropriate for clarity of description.

### First Example Embodiment

### (1A)

Hereinafter, a first example embodiment of the present disclosure will be described with reference to the drawings. In (1A), a video processing apparatus will be described.

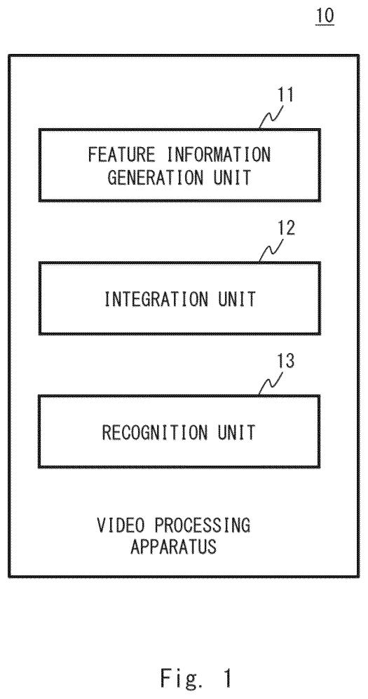

FIG. 1 is a block diagram illustrating an example of a video processing apparatus. A video processing apparatus 10 includes a feature information generation unit 11, an integration unit 12, and a recognition unit 13. Each unit (each means) of the video processing apparatus 10 is controlled by a control unit (controller) not illustrated in the drawings. Each unit will be described below.

### Description of Configuration

The feature information generation unit 11 generates image quality feature information indicating a feature of image quality information indicating an image quality of a video in time and space. The video is data to be subjected to recognition processing on a subject, and is assumed to be acquired by a camera or the like, for example, but is not limited thereto. The video is data including a plurality of still images (hereinafter, also simply referred to as images) in time series. Note that, in the present disclosure, the video and the image can be rephrased with each other. That is, the video processing apparatus 10 can also be said to be a video processing apparatus that processes a video, and can also be said to be an image processing apparatus that processes an image. The video processing apparatus 10 can acquire this video from the outside of the video processing apparatus, for example.

The image quality information is arbitrary information indicating an image quality, and may be, for example, information indicating a compression degree of a region of a frame (frame of an image) included in a video, brightness information or luminance information of the video, or the like. The information indicating the compression degree of the region of the frame included in the video is, for example, a quantization parameter (QP) map which is a map of a feature amount of the image quality information in time and space, but is not limited thereto.

The integration unit 12 generates integrated data obtained by integrating the information regarding the video including the feature of the video in the time and space and the image quality feature information generated by the feature information generation unit 11. The information regarding the video may be information (video feature information) indicating a feature of the video in time and space, which is obtained by performing arbitrary processing on the video, or may be the video itself. More specifically, the video feature information is a feature amount related to a pixel value of the video, and can be represented by, for example, a matrix indicating the feature amount. The video feature information may be generated by the video processing apparatus 10 based on the video, or may be generated by an apparatus outside the video processing apparatus 10.

Further, the integration unit 12 can use any method in the integration as long as the integrated data is integrated data in which the image quality feature information is reflected in the information regarding the video. For example, the integration may be executed by arbitrary arithmetic processing such as multiplication or addition, may be executed by an algorithm based on a rule base defined in advance, or may be executed by an artificial intelligence (AI) model trained in advance, such as a neural network. This will be described later in detail in a second example embodiment.

The recognition unit 13 executes recognition processing on the subject included in the video based on the integrated data generated by the integration unit 12. The recognition unit 13 can perform any recognition processing on the subject, and may specify an attribute of the subject, for example. The attribute of the subject may indicate the type of an object defined for the subject, for example, whether the subject is a person, an organism other than the person, or a machine such as a bicycle, an automobile, or a robot. Further, in a case where the subject is a person, the attribute of the subject may be information that can uniquely identify the subject, such as whether the subject is any one of persons A, B, C . . . stored in the video processing apparatus 10 in advance, or an unknown person that is not stored. Furthermore, in a case where the subject is a person, the attribute of the subject may be information for specifying the occupation of the person who is the subject (for example, whether the person is a worker at a construction site, a plasterer, or a general passerby). In a case where the subject is a machine, the attribute of the subject may be information for specifying the type of the machine, such as whether the subject is a bicycle, an automobile, or an industrial robot. As another example, the recognition unit 13 may specify a motion of the subject. For example, in a case where the recognition unit 13 specifies that the subject is a person, the motion of the subject is an action, and in a case where the recognition unit 13 specifies that the subject is a robot, the motion of the subject is a work content of the robot.

Note that the recognition unit 13 may be, for example, an AI model (for example, a neural network) trained in advance. Training is performed by inputting teacher data including a sample video including a subject and a correct answer label indicating what the subject is for each video or a correct answer label indicating a motion of the subject to the recognition unit 13 (or the video processing apparatus 10). Alternatively, the recognition unit 13 may analyze the video based on a rule base defined in advance, and determine what the subject is or the motion of the subject.

### Description of Processing

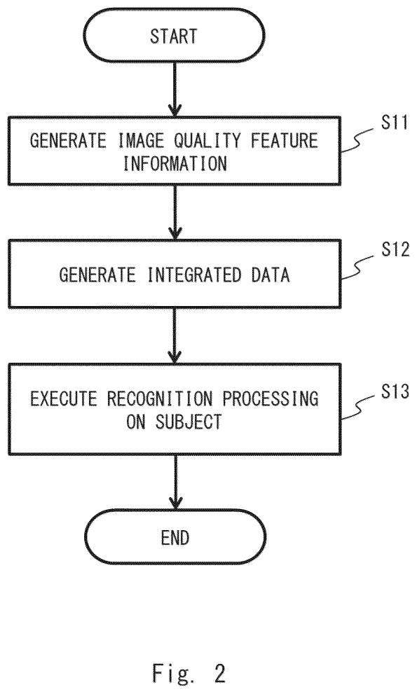

FIG. 2 is a flowchart illustrating an example of representative processing of the video processing apparatus 10, and an outline of processing of the video processing apparatus 10 will be described with this flowchart. Note that, since details of each processing are as described above, description thereof is omitted.

First, the feature information generation unit 11 generates image quality feature information indicating a feature of image quality information indicating an image quality of a video in time and space (step S11; generation step). The integration unit 12 generates integrated data obtained by integrating information regarding the video and the image quality feature information generated by the feature information generation unit (step S12; integration step). The recognition unit 13 executes recognition processing on the subject included in the video based on the integrated data (step S13; recognition step).

### Description of Advantageous Effects

As described above, the recognition unit 13 can execute the recognition processing on the subject based on the integrated data regarding the video reflecting the image quality feature information. That is, even if the image quality changes in the video, the recognition unit 13 can execute the recognition processing after grasping the information as the image quality feature information. Therefore, an influence of the change in image quality occurring in the video can be suppressed, and the accuracy of the video recognition can be improved.

### (1B)

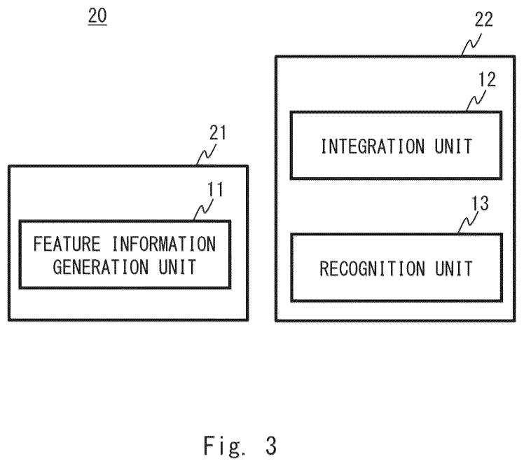

Next, in (1B), a video processing system will be described. FIG. 3 is a block diagram illustrating an example of the video processing system. A video processing system 20 includes a feature information generation apparatus 21 and a recognition apparatus 22. The feature information generation apparatus 21 includes a feature information generation unit 11, and the recognition apparatus 22 includes an integration unit 12 and a recognition unit 13. The feature information generation unit 11 to the recognition unit 13 execute the same processing as that illustrated in (1A). If the feature information generation unit 11 generates the image quality feature information, the generated image quality feature information is output to the recognition apparatus 22. The integration unit 12 executes the processing illustrated in (1A) using the image quality feature information.

As described above, the video processing according to the present disclosure may be implemented by a single apparatus as illustrated in (1A), or may be implemented as a system in which processing to be executed is distributed to a plurality of apparatuses as illustrated in (1B). Note that the apparatus configuration illustrated in (1B) is merely an example. As another example, a first apparatus may include the feature information generation unit 11 and the integration unit 12, and a second apparatus may include the recognition unit 13. In addition, three different apparatuses may be provided, and each apparatus may include the feature information generation unit 11, the integration unit 12, and the recognition unit 13. As still another example, a part or all of the video processing system 20 may be provided in a cloud server constructed on a cloud, or may be provided in another type of virtualization server generated using virtualization technology or the like. Functions other than the functions provided in such a server are disposed at an edge. For example, in a system that monitors a video captured in a site via a network, an edge is an apparatus disposed at the site or near the site, and is an apparatus close to a terminal in a hierarchy of the network.

### Second Example Embodiment

In the following second example embodiment, a specific example of the video processing apparatus 10 described in the first example embodiment is disclosed. However, a specific example of the video processing apparatus 10 illustrated in the first example embodiment is not limited to that described below. In addition, configurations and processes described below are examples, and the present disclosure is not limited thereto.

### (2A)

### Description of Configuration

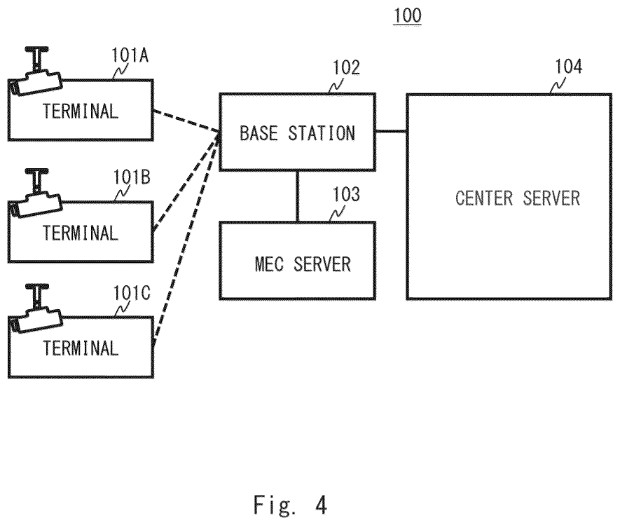

FIG. 4 is a block diagram illustrating an example of a video recognition system. A video recognition system 100 includes a terminal 101, a base station 102, a multi-access edge computing (MEC) server 103, and a center server 104. In the example of FIG. 4, the terminal 101 is provided on an edge side (site side) of the video recognition system 100, and the center server 104 is disposed at a position (cloud side) away from the site. Each apparatus will be described below.

Each of terminals 101A, 101B, and 101C (hereinafter, collectively referred to as the terminal 101) is an edge device connected to a network, and has a camera which is an image capturing unit, and can capture an image of an arbitrary place. The terminal 101 transmits a captured video to the center server 104 via the base station 102. In this example, the terminal 101 transmits the video through a wireless line. However, the video may be transmitted through a wired line.

However, the terminal 101 and the camera may be provided separately. In this case, the camera transmits the captured video to the terminal 101 which is a relay apparatus, and the terminal 101 processes the video as necessary and transmits the processed video to the center server 104 via the base station 102. However, the camera may process the video and transmit the processed video to the terminal 101, and the terminal 101 may transmit the video.

In addition, a bit rate of the video that can be transmitted from the MEC server 103 to the center server 104 is allocated to each terminal 101 as described later. The bit rate of the video means a data amount of the video per unit time (for example, one second). The allocated bit rate may vary with time. Each terminal 101 can decrease (that is, compression is performed) a bit rate of a partial region or an entire region of the captured video by a predetermined ratio such that the bit rate of the video to be transmitted to the center server 104 is equal to or less than the allocated bit rate.

Further, if the terminal 101 detects that a predetermined condition is satisfied, the terminal 101 can decrease a bit rate of a partial region or an entire region of a frame of the captured video by a predetermined ratio. The terminal 101 may execute this processing, for example, by analyzing the captured video. Specifically, if the terminal 101 detects that a predetermined object (for example, a predetermined person) is included in the frame of the captured video, the terminal 101 may decrease the bit rate in a region other than the corresponding region by a predetermined ratio as compared with the bit rate of the corresponding region. However, the terminal 101 can decrease the bit rate in the region including the predetermined object by a predetermined ratio as compared with the bit rate in the other region. As another example, in a case where it is detected that the terminal 101 is in a predetermined environment (for example, in a case where image capturing is performed in a predetermined time zone), the terminal 101 may decrease the bit rate of the entire frame of the captured video by a predetermined ratio.

In this way, at the time the terminal 101 compresses the video under a predetermined condition, the terminal 101 generates QP map information which is information indicating a compression degree of the region of the frame included in the video, and transmits the information to the base station 102. Further, the terminal 101 may uniformly compress the video to be transmitted such that the video can be decompressed by the center server 104 later.

The base station 102 transfers the video transmitted from each terminal 101 to the center server 104 via the network. In addition, the base station 102 transfers a control signal from the MEC server 103 to each terminal 101. For example, the base station 102 is a local 5th Generation (5G) base station, a 5G next Generation Node B (gNB), an LTE evolved Node B (eNB), an access point of a wireless LAN, or the like, but may be another relay apparatus. The network is, for example, a core network such as a 5th Generation Core network (5GC) or an Evolved Packet Core (EPC), the Internet, or the like.

The MEC server 103 allocates a bit rate of a video to be transmitted from each terminal 101 to the base station 102, and transmits information regarding the allocated bit rate of the video to each terminal 101 as control information. Each terminal 101 adjusts the bit rate of the video as described above according to the control information. Note that the base station 102 and the MEC server 103 are connected communicably by an arbitrary communication method, but the base station 102 and the MEC server 103 may constitute one apparatus.

The MEC server 103 detects at least one of a communication environment between each terminal 101 and the base station 102 or a communication environment between the base station 102 and the MEC server 103, and determines the bit rate of the video to be allocated to each terminal 101 based on a detection result. At this time, the MEC server 103 can predict the accuracy with which the center server 104 to be described later recognizes the subject based on the video captured by each terminal 101, and determine the bit rate of the video to be allocated to each terminal 101 such that the prediction accuracy of the recognition regarding the video captured by each terminal 101 becomes the maximum in total.

The MEC server 103 transmits information regarding the determined bit rate to each terminal 101 as control information. Each terminal 101 adjusts the bit rate of the video to be transmitted to the center server 104 based on the control information.

Note that the communication environment between each terminal 101 and the base station 102 may be determined by, for example, at least one of the number of terminals 101, the congestion degree of wireless communication between each terminal 101 and the base station 102, or the quality of the wireless communication. An example of the congestion degree of the wireless communication is the number of packets per unit time, and an example of the quality of the wireless communication is radio wave strength (Received Signal Strength Indicator (RSSI)). However, the present disclosure is not limited thereto. The communication environment between the base station 102 and the MEC server 103 may be determined by, for example, at least one of the congestion degree of the wireless communication between the base station 102 and the MEC server 103 or the quality of the wireless communication. The MEC server 103 can detect at least one of the communication environment between each terminal 101 and the base station 102 or the communication environment between the base station 102 and the MEC server 103 by using the one or more parameters described above.

In addition, the MEC server 103 may set a predetermined condition for decreasing the bit rate of the partial region or the entire region of the video captured by the terminal 101, and transmit setting information to each terminal 101. In a case where it is detected that the predetermined condition has been satisfied based on the setting information, the terminal 101 can decrease the bit rate of the partial region or the entire region of the captured video.

As described above, in the video recognition system 100, the bit rate of the video transmitted from the terminal 101 can be decreased in a predetermined case. As a result, it is possible to reduce a processing load at the time processing is executed on the center server 104 side and a communication load in the system. However, since the communication quality of the network varies, there is a possibility that the video from the terminal 101 is not transmitted with high quality or accurately. Further, at the time a video that is time-series data is transmitted from the terminal 101, block noise may occur due to a variation in communication quality or the like. For this reason, if the image quality of the video changes, there is a possibility that the recognition accuracy of the video decreases in the case of analyzing the video. However, in the center server 104 described below, such an event can be suppressed.

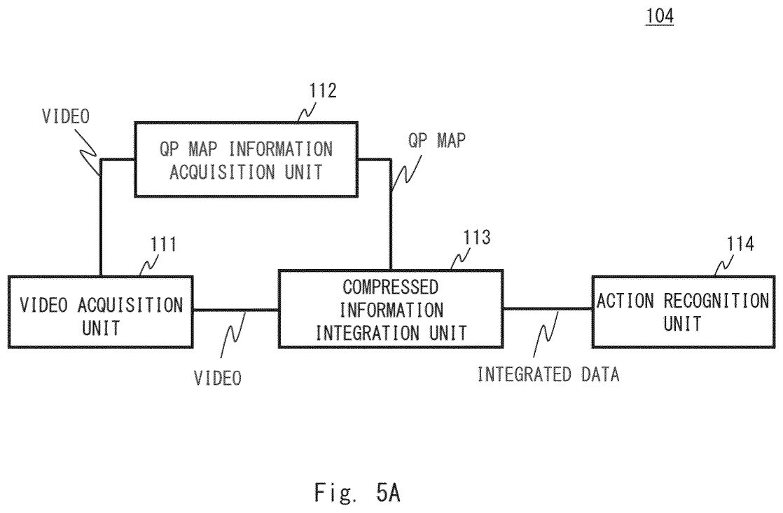

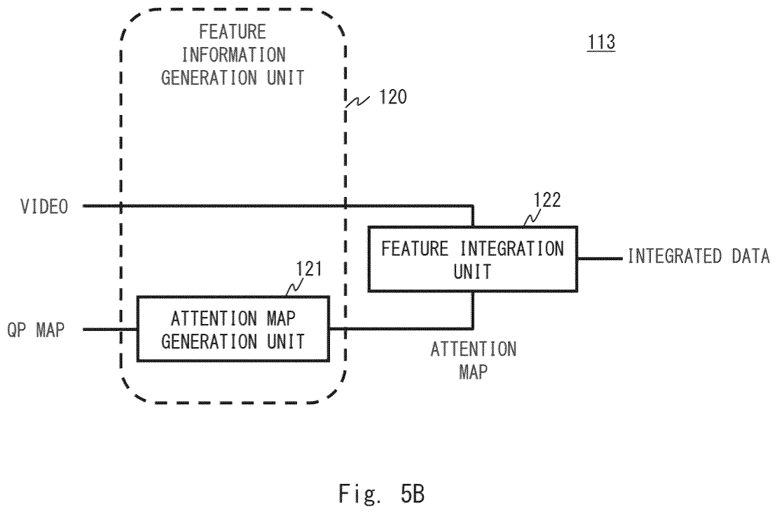

FIG. 5A is a block diagram illustrating an example of a center server. The center server 104 includes a video acquisition unit 111, a QP map information acquisition unit 112, a compressed information integration unit 113, and an action recognition unit 114. The center server 104 executes the following video processing for each terminal 101. Each unit of the center server 104 will be described below.

The video acquisition unit 111 is an interface that acquires a video transmitted from each terminal 101 via the base station 102 and QP map information corresponding to the video. As described in the first example embodiment, the QP map information is information indicating a compression degree of a region of a frame included in the video. Note that, in a case where the video transmitted from each terminal 101 is uniformly compressed, the video acquisition unit 111 executes decompression processing so that recognition processing described later can be executed. The video acquisition unit 111 outputs the acquired information to QP map information acquisition unit 112 and the compressed information integration unit 113.

The QP map information acquisition unit 112 extracts and acquires the QP map information indicating the compression degree of the bit rate of the video from the information acquired from the video acquisition unit 111. If the QP map information is not transmitted from the terminal 101, by analyzing the video output from the video acquisition unit 111, the QP map information acquisition unit 112 can acquire the QP map information corresponding to the video. The QP map information acquisition unit 112 outputs the acquired QP map information to the compressed information integration unit 113.

The compressed information integration unit 113 generates integrated data obtained by integrating the video and the image quality feature information created based on the QP map information for each frame of the video, and outputs the generated integrated data to the action recognition unit 114. This will be described below in detail.

The action recognition unit 114 corresponds to the recognition unit 13 according to the first example embodiment, and recognizes an action of a person who is the subject of the video by analyzing the integrated data output from the compressed information integration unit 113. The action recognition unit 114 may be an AI model (for example, a neural network) trained in advance. Since a method of this training is similar to that of the recognition unit 13, the description thereof will be omitted. Alternatively, the action recognition unit 114 may determine a motion of the subject by analyzing the video based on a rule base defined in advance.

FIG. 5B is a block diagram illustrating an example of the compressed information integration unit 113. The compressed information integration unit 113 includes a feature information generation unit 120 including an attention map generation unit 121 and a feature integration unit 122. Each unit of the compressed information integration unit 113 will be described below.

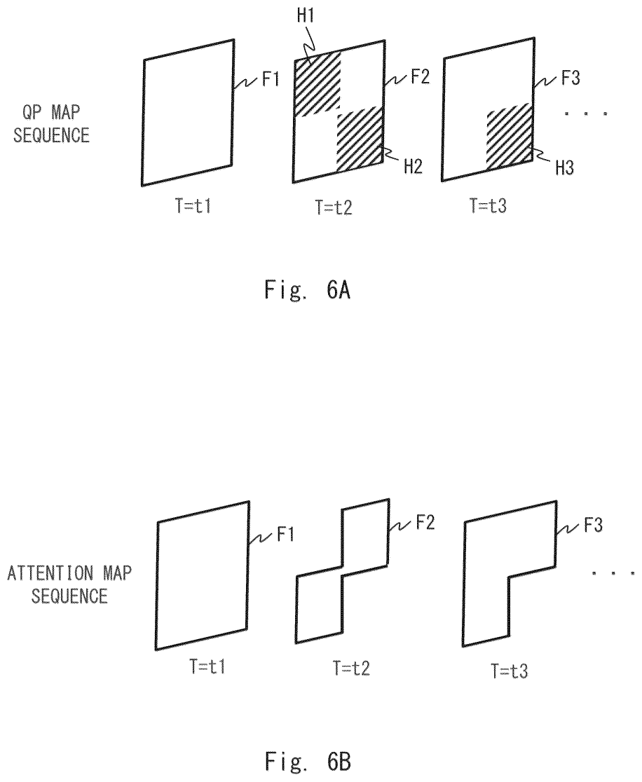

The feature information generation unit 120 corresponds to the feature information generation unit 11 according to the first example embodiment. Using the QP map information output from the QP map information acquisition unit 112, the attention map generation unit 121 included in the feature information generation unit 120 generates, for each frame of the video, attention map information indicating a region to which attention is to be paid (hereinafter, also referred to as an attention region) in the recognition processing in the frame. The attention map information is a map of a feature amount of the QP map information in time and space. Hereinafter, an example in which the attention map generation unit 121 generates the attention map information will be described with reference to FIGS. 6A and 6B.

FIG. 6A is a diagram illustrating an example of the QP map information, and illustrates the QP map information (QP map sequence) for each frame in the time series of time T=t1, t2, t3, . . . . F1 to F3 in the QP map at each time indicate regions of the entire frame. Therefore, the QP map information indicates spatiotemporal information.

In FIG. 6A, hatched regions H1 and H2 in the frame F2 are regions having a larger compression degree than the other regions in the frame F2. For example, it is assumed that the terminal 101 performs processing of decreasing the bit rate of the video on the hatched regions Hl and H2, but does not perform the processing of decreasing the bit rate of the video on the other regions. Alternatively, the terminal 101 may perform processing of greatly decreasing the bit rate of the video on the hatched regions Hl and H2, and perform processing of decreasing the degree of decrease in the bit rate on the other regions as compared with the hatched regions H1 and H2. Similarly, a hatched region H3 in the frame

F3 is a region having a larger compression degree than the other regions in the frame F3. In this manner, the QP map sequence indicates the compression degree of the video bit rate in time and space.

Note that, in the QP map sequence, positions and sizes of a region having a large compression degree and a region having a small compression degree change according to the time change. For example, at a certain time, a region having a large compression degree may exist in the entire frame, at another time, a region having a small compression degree may exist in the entire frame, and at still another time, a region having a large compression degree and a region having a small compression degree may be mixed in the frame.

Since the bit rate of the video decreases in the hatched regions H1 to H3, it is considered that it is difficult to perform accurate recognition processing (inference processing) on the region, even if the video of the region is input to the action recognition unit 114. In addition, setting such a region as a target of the recognition processing leads to an increase in processing load of the center server 104.

The attention map generation unit 121 determines whether or not there is a region in which the bit rate is decreased from a reference value by a predetermined threshold or more in the QP map for each time illustrated in FIG. 6A. In a case where there is a region in which the degree of decrease in the bit rate is equal to or more than the predetermined threshold, the attention map generation unit 121 excludes the region from an attention region. That is, the attention map generation unit 121 masks the region. On the other hand, in a case where there is a region in which the degree of decrease in the bit rate is less than the predetermined threshold, the attention map generation unit 121 leaves the region as an attention region (that is, a region effective in the inference processing). Note that information regarding the reference value and the threshold used for the determination is stored in a storage unit (not illustrated) in the center server 104, and the attention map generation unit 121 acquires the information at the time of executing this determination.

FIG. 6B is a diagram illustrating an example of the attention map information generated by the attention map generation unit 121 based on the QP map information illustrated in FIG. 6A, and illustrates the attention map information (attention map sequence) for each frame in the time series of time T=t1, t2, t3, . . . . F1 to F3 in the QP map at each time indicate regions of the entire frame. At this time, since the hatched regions H1 to H3 are determined to be regions where the degree of decrease in the bit rate is equal to or more than the predetermined threshold by the above-described determination, the hatched regions H1 to H3 are excluded from the regions in the attention map sequence. In this example, in the attention map sequence, weighting is performed such that the weight of each pixel information of the excluded regions is “0” and the weight of each pixel information in each pixel of the other regions is “1”.

Note that the pixel information refers to a value stored for a predetermined unit region in the frame of the image or the attention map, and may be, for example, a pixel value (actual RGB value stored in each pixel of the image, or the like), but is not limited thereto. Using the QP map sequence, the attention map generation unit 121 defines the weighting as described above such that the weight becomes “0” or “1” for the unit region in each frame of the time series. For example, the attention map generation unit 121 may set the hatched region H1 as one unit region, and define the weight of the region as “0”. Alternatively, the attention map generation unit 121 may set unit regions such that the hatched region Hl includes a plurality of unit regions, and define the weight of each unit region as “0”. The unit region in this case includes one or a plurality of pixels. The attention map generation unit 121 outputs the attention map information to the feature integration unit 122.

The feature integration unit 122 corresponds to the integration unit 12 according to the first example embodiment, and integrates the generated attention map information and the video. For example, the feature integration unit 122 may generate integrated data by multiplying each pixel information of the attention map information at each time by each pixel information (for example, information regarding a pixel value) of the corresponding video. In the above-described example of the attention map information, since the weight of each pixel information in the excluded region is “0”, the information in each pixel of this region is also “0” on the integrated data. Therefore, the integrated data includes an image in which the excluded region is masked, and this image represents a region to which attention is to be paid for the recognition processing.

The feature integration unit 122 outputs integrated data in which the attention region has been weighted in the time and space in this manner to the action recognition unit 114. The action recognition unit 114 executes recognition processing based on the integrated data. In this recognition processing, a region other than the attention region is suppressed from being a target of the recognition processing, and a region of a video having high quality and easy to analyze is a target of the recognition processing. As a result, it is possible to increase the accuracy of the recognition processing and to suppress the processing load of the recognition processing.

### Description of Processing

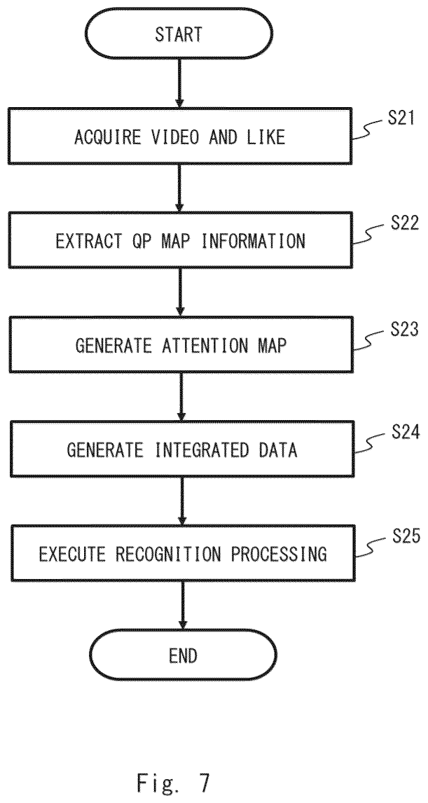

FIG. 7 is a flowchart illustrating an example of representative processing of the center server 104, and an outline of processing of the center server 104 will be described with this flowchart. Note that, since details of each processing are as described above, description thereof is omitted.

First, the video acquisition unit 111 acquires the video transmitted from each terminal 101 and the QP map information corresponding to the video (step S21; acquisition step). The QP map information acquisition unit 112 extracts the QP map information from the information acquired from the video acquisition unit 111 (step S22; extraction step).

The attention map generation unit 121 generates the attention map information using the extracted QP map (step S23; generation step). The feature integration unit 122 integrates the generated attention map information and the video to generate integrated data (step S24; integration step). The action recognition unit 114 executes recognition processing based on the integrated data (step S25; recognition step).

### Description of Advantageous Effects

As described above, the attention map generation unit 121 generates the attention map information (image quality feature information) indicating the feature in the time and space by using the QP map information (image quality information) indicating the image quality of the video. The feature integration unit 122 generates the integrated data obtained by integrating the video and the attention map information, and the action recognition unit 114 executes recognition processing on the subject included in the video based on the integrated data. The action recognition unit 114 can execute the recognition processing after grasping a region in the video in which the bit rate greatly decreases. Therefore, an influence of the change in image quality occurring in the video can be suppressed, and the accuracy of the video recognition can be improved.

Further, the attention map generation unit 121 may generate attention map information indicating the weight of the pixel information in the frame of the video based on the QP map information. The feature integration unit 122 generates a video in which weighting is performed in pixels of the frame of the video as integrated data based on the attention map information. As a result, since the action recognition unit 114 can analyze the integrated data by a method similar to a method for a normal video, it is not necessary to cause an action recognition function mounted on the center server 104 to be special, and the cost can be suppressed.

Further, as the image quality information indicating the image quality of the video, QP map information which is information indicating the compression degree of the region of the frame included in the video may be used. As a result, the action recognition unit 114 is suppressed from analyzing a region having a large compression degree. Therefore, as described above, it is possible to increase the accuracy of the recognition processing and to suppress the processing load of the recognition processing.

The action recognition unit 114 may recognize the action of the subject. For the above reason, the action recognition unit 114 can determine the action of the subject with high accuracy.

In (2A), as described above, the attention map generation unit 121 can generate the attention map information from the QP map information by the determination of the algorithm based on the rule base using the threshold.

However, the attention map generation unit 121 may be an AI model (for example, a neural network) trained in advance. This training is performed by inputting teacher data including QP map information as a sample and a correct answer label indicating attention map information corresponding to each frame of the sample QP map information to the AI model. Also, by this method, the attention map generation unit 121 can generate the attention map information in which a region that is considered to be difficult to perform accurate recognition processing has been masked.

Hereinafter, in (2B) and (2C), variations of (2A) will be described. (2B)

In (2A), the attention map generation unit 121 generates attention map information in which the region where the degree of decrease in the bit rate from the reference value is equal to or more than the predetermined threshold has been masked. However, even in such a region, in some cases, it is considered that the region is useful for the action recognition processing. Therefore, in (2B), a variation of generating the attention map information in consideration of such a region will be described.

Specifically, in (2A), by setting the weight of each pixel information of the region where the degree of decrease in the bit rate is equal to or more than the predetermined threshold to “0”, the attention map generation unit 121 masks the region. However, even for the region where the degree of decrease in the bit rate is equal to or more than the predetermined threshold, the attention map generation unit 121 may not necessarily set the weight of the pixel information of the region to “0”, and may set the weight to a numerical value larger than 0 and less than 1. In this case, even in the region where the degree of decrease in the bit rate is equal to or more than the predetermined threshold, the weight of the information decreases, but the region is a target of recognition processing in the action recognition unit 114.

In this example, the attention map generation unit 121 is set as a neural network trained in advance. At the time of training of the neural network, a sample video including a plurality of images to be samples is input to the center server 104 as a video. The video acquisition unit 111 to the action recognition unit 114 of the center server 104 execute the above-described processing on the acquired sample video. At this time, training of the attention map generation unit 121 is performed that a loss function calculated based on the recognition result of the action recognition unit 114 and the correct answer label of the action recognition corresponding to the sample video is equal to or less than a predetermined threshold. For example, the loss function may be trained so as to have a minimum value among values that can be taken by the function. The loss function is, for example, a cross entropy loss or a mean square error, but is not limited thereto. By this training, the setting of weight in the attention map generation unit 121 is updated such that the weight of the pixel information is a value other than “0” according to the situation, even for the region where the degree of decrease in the bit rate is equal to or more than the predetermined threshold.

The feature integration unit 122 integrates the attention map information generated by the attention map generation unit 121 as described above and the video. As described above, the feature integration unit 122 generates integrated data by, for example, multiplying each pixel information of the attention map information at each time by each pixel information of the corresponding video. The integrated data generated by the feature integration unit 122 can be said to be a video weighted according to an attention degree of the attention region in the time and space. The action recognition unit 114 executes recognition processing for the integrated data.

In the example described above, the region where the degree of decrease in the bit rate is equal to or more than the predetermined threshold is not uniformly set as the target of the mask processing, and the weighting of the pixel information can be flexibly set. As a result, the accuracy of the recognition processing by the action recognition unit 114 can be further improved. Furthermore, as a result of training, even for a region where the degree of decrease in the bit rate is less than the predetermined threshold, the attention map generation unit 121 does not necessarily set the weight of the pixel information of the region to “1”, and can also set the weight to a numerical value larger than 0and less than 1. The attention map generation unit 121 suppresses such a region from being set as a recognition processing target in the recognition processing by the action recognition unit 114. As a result, the recognition processing can be efficiently performed. For example, as a result of training, the attention map generation unit 121 can set the weight of each pixel information based on the information regarding the variation in the bit rate in the time and space of the QP map sequence.

In (2B), the attention map generation unit 121 may be another type of AI model trained in advance, instead of the neural network. Furthermore, the attention map generation unit 121 may set a region where the weight of the pixel information is a value other than “0” and “1” by determination based on a rule base instead of the AI model. For example, two types of determination thresholds may be set, and for a region where the degree of decrease in the bit rate from the reference value is equal to or more than a first threshold Th1 and less than a second threshold Th2 (Th2>Th1), the weight of each pixel information of the region may be set to a numerical value larger than 0 and less than 1. Three or more types of thresholds can also be set. As described above, the attention map generation unit 121 may determine the weight of the pixel information in stages based on the degree of decrease in the bit rate from the reference value by an arbitrary method.

### (2C)

In (2A) and (2B), the video is integrated with the attention map information in the feature integration unit 122. However, the feature integration unit 122 may generate integrated data in which the attention map information and the video feature information indicating the feature of the video in the time and space have been integrated.

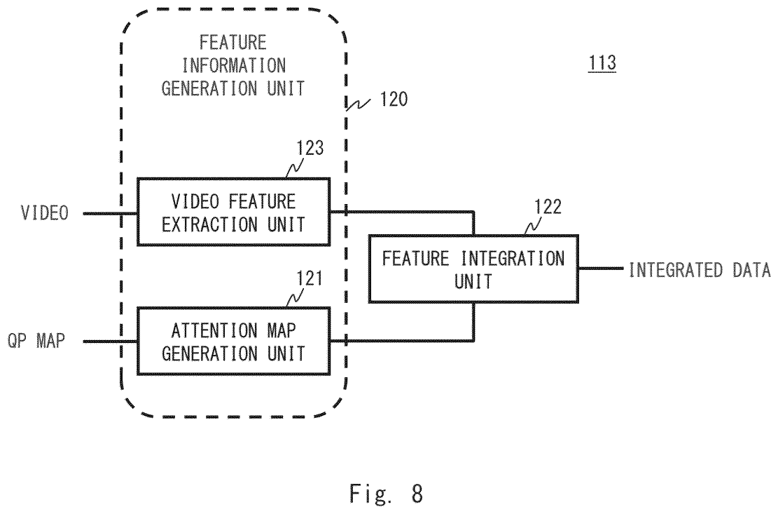

FIG. 8 is a block diagram illustrating another example of the compressed information integration unit. In the compressed information integration unit 113 illustrated in FIG. 8, the feature information generation unit 120 further includes a video feature extraction unit 123 in addition to the attention map generation unit 121. Each unit will be described below.

As illustrated in (2A), the attention map generation unit 121 generates the attention map information (image quality feature information) indicating the feature in the time and space by using the QP map information indicating the image quality of the video. The attention map generation unit 121 outputs the attention map information to the feature integration unit 122.

Here, as illustrated in (2B), the attention map generation unit 121 may be a neural network trained in advance. Since training of this neural network is as described in (2B), description thereof is omitted.

The video feature extraction unit 123 generates video feature information indicating a feature of an image for each frame at each time of the video, and outputs the video feature information to the feature integration unit 122. The video feature information can be expressed as, for example, a feature amount matrix.

In this example, the video feature extraction unit 123 is set as a neural network trained in advance. At the time of training of the neural network, a sample video including a plurality of videos to be samples is input to the center server 104 as a video. The video acquisition unit 111 to the action recognition unit 114 of the center server 104 execute the above-described processing on the acquired sample video. At this time, the training of the video feature extraction unit 123 is performed such that the loss function calculated based on the recognition result of the action recognition unit 114 and the correct answer label of the action recognition corresponding to the sample video is equal to or less than the predetermined threshold. For example, the loss function may be trained so as to have a minimum value among values that can be taken by the function. The loss function is, for example, a cross entropy loss or a mean square error, but is not limited thereto.

The feature integration unit 122 generates integrated data in which the attention map information and the video feature information have been integrated. For example, the feature integration unit 122 may generate integrated data by adding each pixel information of the attention map information at each time and each pixel information of the corresponding video feature information. As a result, the feature in the image is emphasized as the feature amount in the time and space, and is reflected in the integrated data. However, the feature integration unit 122 may generate integrated data by processing other than addition. The feature integration unit 122 outputs the generated integrated data to the action recognition unit 114.

Furthermore, as another example, the feature integration unit 122 may be implemented by an AI model trained in advance, instead of processing based on a rule base. For example, the feature integration unit 122 may be implemented by a neural network. At the time of training of the neural network, a sample video including a plurality of videos to be samples is input to the center server 104 as a video. The video acquisition unit 111 to the action recognition unit 114 of the center server 104 execute the above-described processing on the acquired sample video. At this time, the training of the feature integration unit 122 is performed such that the loss function calculated based on the recognition result of the action recognition unit 114 and the correct answer label of the action recognition corresponding to the sample video is equal to or less than the predetermined threshold. For example, the loss function may be trained so as to have a minimum value among values that can be taken by the function. The loss function is, for example, a cross entropy loss or a mean square error, but is not limited thereto.

With the configuration described above, the action recognition unit 114 executes the recognition processing on the integrated data in which the attention map information and the video feature information have been integrated. At this time, since the feature information of the video is already indicated in the integrated data, there is no need to perform processing of extracting the feature amount of the image on the action recognition unit 114 side. Therefore, the function of the action recognition unit 114 can be simplified.

In addition, the video feature extraction unit 123 that generates the video feature information can include a trained neural network. As a result, it is possible to accurately capture the feature in the video, and it is possible to improve the accuracy of the action recognition in the action recognition unit 114.

In (2C), the video feature extraction unit 123 may be another type of AI model trained in advance, instead of the neural network. In addition, the video feature extraction unit 123 may generate video feature information indicating a feature of an image for each frame by determination based on a rule base.

Note that the technical ideas of the present disclosure are not limited to the above-described example embodiments, and can be appropriately modified without departing from the scope.

For example, in the second example embodiment, at least one of the brightness information or the luminance information in the video may be used instead of or in addition to the QP map information. In a region where brightness is higher than a predetermined threshold in a video, the accuracy of video recognition may decrease. Therefore, by generating the image quality feature information using the brightness information or the luminance information and performing the recognition processing on the integrated data reflecting the image quality feature information, even in a case where there is a region with high brightness in the video, an influence in the recognition processing can be suppressed.

In (2A) and (2B), the weight of each pixel information of the attention map information generated by the attention map generation unit 121 has a value of 0 or more and 1 or less. However, the value that can be taken by the weight of each pixel information is not limited thereto. For example, the weight of each pixel information may be set to be a value equal to or more than 0 and equal to or less than an arbitrary positive numerical value, or may be set to be able to take a negative value.

In the MEC server 103, the information regarding the bit rate allocated for each terminal 101 may be transmitted from the MEC server 103 to the center server 104. Based on the value, the attention map generation unit 121 may change the parameter for generating the attention map information with respect to the video transmitted from each terminal 101. For example, as illustrated in (2A) and (2B), in a case where the attention map generation unit 121 determines whether or not there is a region where the degree of decrease in the bit rate from the reference value is equal to or more than the predetermined threshold, the attention map generation unit 121 can change at least one of the reference value or the threshold according to the change in the bit rate. As an example, in a case where the bit rate allocated to the terminal 101A decreases, the attention map generation unit 121 may decrease the reference value and the threshold of the above determination regarding the video of the terminal 101A. In this way, the attention map generation unit 121 can perform determination in consideration of the bit rate of the entire video for each terminal 101 and generate the highly accurate attention map. Therefore, the action recognition unit 114 can execute the recognition processing with high accuracy.

The center server 104 may output alert information based on the recognition result of the action recognition unit 114. For example, in a case where the action recognition unit 114 determines that a person in a video performs a predetermined action, the center server 104 can present alert information to an interface such as a screen. Furthermore, the center server 104 can also display a graphical user interface (GUI) on the screen of the display unit, and display a video acquired from the terminal 101, a recognition result of the action recognition unit 114, an alert, and the like on the GUI.

In the second example embodiment, the compressed information integration unit 113 and the action recognition unit 114 are provided in the center server 104 which is a single apparatus. However, some arbitrary processing of the compressed information integration unit 113 and the action recognition unit 114 may be executed by another apparatus instead of the center server 104. That is, as described in (1B) of the first example embodiment, the processing of the compressed information integration unit 113 and the action recognition unit 114 may be implemented as a system distributed in a plurality of apparatuses.

In the example embodiments described above, the disclosure has been described as a hardware configuration, but the disclosure is not limited thereto. In the disclosure, the processing (steps) in the video processing apparatus, the apparatus in the video processing system, or the center server described in the above-described example embodiments can be also implemented by causing a processor in a computer to execute a computer program.

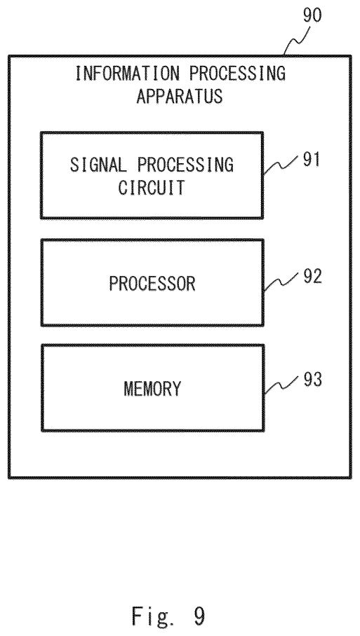

FIG. 9 is a block diagram illustrating a hardware configuration example of the information processing apparatus in which the processing of each example embodiment described above is executed. Referring to FIG. 9, an information processing apparatus 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected (coupled) to the memory 93, and reads and executes software (computer program) from the memory 93 to execute the processing in the apparatus described in the above-described example embodiments. As an example of the processor 92, one of a central processing unit (CPU), a micro processing unit (MPU), a field-programmable gate array (FPGA), a demand-side platform (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a read only memory (ROM) such as a programmable random only memory (PROM) or an erasable programmable read only memory (EPROM), a flash memory, or a solid state drive (SSD).

The memory 93 is used to store one or more instructions. Here, one or more instructions are stored in the memory 93 as a software module group. The processor 92 can execute the processing described in the above-described example embodiments by reading and executing these software module groups from the memory 93.

Note that the memory 93 may include a memory built in the processor 92 in addition to a memory provided outside the processor 92. The memory 93 may include a storage disposed away from a processor implementing the processor 92. In this case, the processor 92 can access the memory 93 via an input/output (I/O) interface.

As described above, one or more processors included in each apparatus of the example embodiments execute one or more programs including a group of instructions for causing a computer to execute an algorithm described with reference to the drawings. By this processing, the information processing method described in each example embodiment may be implemented.

The program includes a group of instructions (or software code) for causing the computer to perform one or more functions described in the example embodiments if the program is loaded into the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Some or all of the above-described example embodiments may be described as in the following Supplementary Notes, but are not limited to the following Supplementary Notes.

### (Supplementary Note 1)

A video processing apparatus including:
a feature information generation unit configured to generate image quality feature information indicating a feature of image quality information indicating an image quality of a video in time and space;
an integration unit configured to generate integrated data obtained by integrating information regarding a video including a feature of the video in time and space and the image quality feature information generated by the feature information generation unit; and
a recognition unit configured to execute recognition processing on a subject included in the video based on the integrated data.

### (Supplementary Note 2)

The video processing apparatus according to Supplementary Note 1, wherein
the feature information generation unit generates the image quality feature information indicating a weight of pixel information in a frame of the video based on the image quality information, and
the integration unit generates a video in which weighting is performed in pixels of the frame of the video as the integrated data, based on the image quality feature information.

### (Supplementary Note 3)

The video processing apparatus according to Supplementary Note 1, wherein
the feature information generation unit generates the image quality feature information indicating a map of a feature amount of the image quality information in time and space, and
the integration unit generates the integrated data obtained by integrating the image quality feature information and video feature information that is information regarding the video and indicates a feature of the video in time and space.

### (Supplementary Note 4)

The video processing apparatus according to Supplementary Note 3, wherein the feature information generation unit further generates the video feature information based on the video.

### (Supplementary Note 5)

The video processing apparatus according to any one of Supplementary Notes 1 to 4, wherein the feature information generation unit includes a neural network trained such that a loss function calculated based on a recognition result of the recognition unit and a correct answer label of action recognition corresponding to a sample video to be sampled is equal to or less than a predetermined threshold, if the feature information generation unit acquires the sample video as the video.

### (Supplementary Note 6)

The video processing apparatus according to any one of Supplementary Notes 1 to 5, wherein the image quality information is information indicating a compression degree of a region of a frame included in the video.

### (Supplementary Note 7)

The video processing apparatus according to any one of Supplementary Notes 1 to 6, wherein the recognition unit recognizes an action of the subject.

### (Supplementary Note 8)

A video processing system including:
a feature information generation unit configured to generate image quality feature information indicating a feature of image quality information indicating an image quality of a video in time and space;
an integration unit configured to generate integrated data obtained by integrating information regarding a video including a feature of the video in time and space and the image quality feature information generated by the feature information generation unit; and
a recognition unit configured to execute recognition processing on a subject included in the video based on the integrated data.

### (Supplementary Note 9)

The video processing system according to Supplementary Note 8, wherein
the feature information generation unit generates the image quality feature information indicating a weight of pixel information in a frame of the video based on the image quality information, and
the integration unit generates a video in which weighting is performed in pixels of the frame of the video as the integrated data, based on the image quality feature information.

### (Supplementary Note 10)

The video processing system according to Supplementary Note 8, wherein
the feature information generation unit generates the image quality feature information indicating a map of a feature amount of the image quality information in time and space, and
the integration unit generates the integrated data obtained by integrating the image quality feature information and video feature information that is information regarding the video and indicates a feature of the video in time and space.

### (Supplementary Note 11)

The video processing system according to Supplementary Note 10, wherein the feature information generation unit further generates the video feature information based on the video.

### (Supplementary Note 12)

The video processing system according to any one of Supplementary Notes 8 to 11, wherein the feature information generation unit includes a neural network trained such that a loss function calculated based on a recognition result of the recognition unit and a correct answer label of action recognition corresponding to a sample video to be sampled is equal to or less than a predetermined threshold, if the feature information generation unit acquires the sample video as the video.

### (Supplementary Note 13)

The video processing system according to any one of Supplementary Notes 8 to 12, wherein the image quality information is information indicating a compression degree of a region of a frame included in the video.

### (Supplementary Note 14)

The video processing system according to any one of Supplementary Notes 8 to 13, wherein the recognition unit recognizes an action of the subject.

### (Supplementary Note 15)

A video processing method executed by a computer, including:
generating image quality feature information indicating a feature of image quality information indicating an image quality of a video in time and space;
generating integrated data obtained by integrating information regarding a video including a feature of the video in time and space and the image quality feature information; and
executing recognition processing on a subject included in the video based on the integrated data.

### (Supplementary Note 16)

The video processing method according to Supplementary Note 15, further including:
generating the image quality feature information indicating a weight of pixel information in a frame of the video based on the image quality information; and
generating a video in which weighting is performed in pixels of the frame of the video as the integrated data, based on the image quality feature information.

### (Supplementary Note 17)

The video processing method according to Supplementary Note 15, further including:
generating the image quality feature information indicating a map of a feature amount of the image quality information in time and space; and generating the integrated data obtained by integrating the image quality feature information and video feature information that is information regarding the video and indicates a feature of the video in time and space.

### (Supplementary Note 18)

The video processing method according to Supplementary Note 17, further including generating the video feature information based on the video.

### (Supplementary Note 19)

The video processing method according to any one of Supplementary Notes 15 to 18, wherein training is performed such that a loss function calculated based on a recognition result of the recognition processing and a correct answer label of action recognition corresponding to a sample video to be sampled is equal to or less than a predetermined threshold, if the sample video is input as the video.

### (Supplementary Note 20)

The video processing method according to any one of Supplementary Notes 15 to 19, wherein the image quality information is information indicating a compression degree of a region of a frame included in the video.

### (Supplementary Note 21)

The video processing method according to any one of Supplementary Notes 15 to 20, wherein an action of the subject is recognized in the recognition processing.

### (Supplementary Note 22)

A non-transitory computer-readable medium storing a program for causing a computer to perform:
generating image quality feature information indicating a feature of image quality information indicating an image quality of a video in time and space;
generating integrated data obtained by integrating information regarding a video including a feature of the video in time and space and the image quality feature information; and
executing recognition processing on a subject included in the video based on the integrated data.

Although the present disclosure has been described above with reference to the example embodiments, the present disclosure is not limited to the above.

Various modifications that could be understood by those skilled in the art can be made to the configurations and details of the present disclosure within the scope of the disclosure.

### REFERENCE SIGNS LIST

10 VIDEO PROCESSING APPARATUS
11 FEATURE INFORMATION GENERATION UNIT
12 INTEGRATION UNIT
13 RECOGNITION UNIT
20 VIDEO PROCESSING SYSTEM
21 FEATURE INFORMATION GENERATION APPARATUS
22 RECOGNITION APPARATUS
100 VIDEO RECOGNITION SYSTEM
10 TERMINAL
102 BASE STATION
103 MEC SERVER
104 CENTER SERVER
111 VIDEO ACQUISITION UNIT
112 QP MAP INFORMATION ACQUISITION UNIT
113 COMPRESSED INFORMATION INTEGRATION UNIT
114 ACTION RECOGNITION UNIT
120 FEATURE INFORMATION GENERATION UNIT
121 ATTENTION MAP GENERATION UNIT
122 FEATURE INTEGRATION UNIT
123 VIDEO FEATURE EXTRACTION UNIT

What is claimed is:

1. A video processing apparatus comprising:
at least one memory configured to store instructions; and
at least one processor configured to execute the instructions to:
generate image quality feature information indicating a feature of image quality information indicating an image quality of a video in time and space;
generate integrated data obtained by integrating information regarding a video including a feature of the video in time and space and the image quality feature information; and
execute recognition processing on a subject included in the video based on the integrated data.

2. The video processing apparatus according to claim 1, wherein the at least one processor is further configured to:
generate the image quality feature information indicating a weight of pixel information in a frame of the video based on the image quality information, and
generate a video in which weighting is performed in pixels of the frame of the video as the integrated data, based on the image quality feature information.

3. The video processing apparatus according to claim 1, wherein the at least one processor is further configured to:
generate the image quality feature information indicating a map of a feature amount of the image quality information in time and space, and
generate the integrated data obtained by integrating the image quality feature information and video feature information that is information regarding the video and indicates a feature of the video in time and space.

4. The video processing apparatus according to claim 3, wherein the at least one processor is further configured to generate the video feature information based on the video.

5. The video processing apparatus according to claim 1, wherein the video processing apparatus further includes a neural network trained such that a loss function calculated based on a recognition result of the recognition processing and a correct answer label of action recognition corresponding to a sample video to be sampled is equal to or less than a predetermined threshold, if the at least one processor acquires the sample video as the video.

6. The video processing apparatus according to claim 1, wherein the image quality information is information indicating a compression degree of a region of a frame included in the video.

7. The video processing apparatus according to claim 1, wherein the at least one processor further recognizes an action of the subject.

8. A video processing system comprising:
at least one memory configured to store instructions; and
at least one processor configured to execute the instructions to:
generate image quality feature information indicating a feature of image quality information indicating an image quality of a video in time and space;
generate integrated data obtained by integrating information regarding a video including a feature of the video in time and space and the image quality feature information; and
execute recognition processing on a subject included in the video based on the integrated data.

9. The video processing system according to claim 8, wherein the at least one processor is further configured to:
generate the image quality feature information indicating a weight of pixel information in a frame of the video based on the image quality information, and
generate a video in which weighting is performed in pixels of the frame of the video as the integrated data, based on the image quality feature information.

10. The video processing system according to claim 8, wherein the at least one processor is further configured to:
generate the image quality feature information indicating a map of a feature amount of the image quality information in time and space, and
generate the integrated data obtained by integrating the image quality feature information and video feature information that is information regarding the video and indicates a feature of the video in time and space.

11. The video processing system according to claim 10, wherein the at least one processor is further configured to generate the video feature information based on the video.

12. The video processing system according to claim 8, wherein the video processing apparatus further includes a neural network trained such that a loss function calculated based on a recognition result of the recognition processing and a correct answer label of action recognition corresponding to a sample video to be sampled is equal to or less than a predetermined threshold, if the at least one processor acquires the sample video as the video.

13. The video processing system according to claim 8, wherein the image quality information is information indicating a compression degree of a region of a frame included in the video.

14. The video processing system according to claim 8, wherein the at least one processor further recognizes an action of the subject.

15. A video processing method executed by a computer, comprising:
generating image quality feature information indicating a feature of image quality information indicating an image quality of a video in time and space;
generating integrated data obtained by integrating information regarding a video including a feature of the video in time and space and the image quality feature information; and
executing recognition processing on a subject included in the video based on the integrated data.

16. The video processing method according to claim 15, further comprising:
generating the image quality feature information indicating a weight of pixel information in a frame of the video based on the image quality information; and
generating a video in which weighting is performed in pixels of the frame of the video as the integrated data, based on the image quality feature information.

17. The video processing method according to claim 15, further comprising:
generating the image quality feature information indicating a map of a feature amount of the image quality information in time and space; and
generating the integrated data obtained by integrating the image quality feature information and video feature information that is information regarding the video and indicates a feature of the video in time and space.

18. The video processing method according to claim 17, further comprising generating the video feature information based on the video.

19. The video processing method according to claim 15, wherein training is performed such that a loss function calculated based on a recognition result of the recognition processing and a correct answer label of action recognition corresponding to a sample video to be sampled is equal to or less than a predetermined threshold, if the sample video is input as the video.

20. The video processing method according to claim 15, wherein the image quality information is information indicating a compression degree of a region of a frame included in the video.
